(19) United States
(12) Patent Application Publication
(10) Pub. No.: US 2021/0298321 A1
(43) Pub. Date: Sep. 30, 2021

(54) Aerated Food Products and Methods for Making Aerated Food Products

(71) Applicant: Frito-Lay North America, Inc., Plano, TX (US)

(72) Inventors: Maria Jose Mendizabal, Plano, TX (US); Frederique Rautureau, Apodaca (MX); Hector Hiram Cepeda Garza, Plano, TX (US)

(21) Appl. No.: 16/830,071

(22) Filed: Mar. 25, 2020

(51) Int. Cl. A23G 3/52; A23G 3/44; A23G 3/46; A23G 3/48

(52) U.S. Cl. CPC A23G 3/52; A23G 3/44; A23G 3/46; A23G 3/48; A23G 2220/02; A23G 2200/10; A23G 2200/12; A23G 2200/14; A23G 2200/06

(57) ABSTRACT

An aerated food product includes a base ingredient, a protein and a liquid and, in some instances, a carbohydrate source. The base ingredient may include a whole grain source, a fiber source, a fruit source, a vegetable source, or a combination thereof. In some aspects, the product has a moisture content in the range of about 1% to about 5%. In one embodiment, the product has a density in the range of about 0.02 g/cc to about 0.50 g/cc. In some embodiments the product has a porosity in the range of about 15% to about 65%. In some embodiments, the product has a texture hardness in the range of about 1 kg to about 7 kg.

The present disclosure relates to aerated food products and methods for forming aerated food products. Desirably, the described aerated food products are made with a minimum amount of ingredients to provide a “clean label” snack product and to provide desirable organoleptic properties.

### BACKGROUND

Increasingly, consumers desire clean label products, particularly, clean label food products that do not contain a significant amount of calories. A “clean label” product refers to a product that typically includes food products that contain natural, familiar, simple ingredients that are easy to recognize, understand, and pronounce and that generally do not contain artificial ingredients or synthetic chemicals.

In addition, consumers also wish to limit their caloric intake. One manner of reducing the amount of calories in a food product is to aerate the product so that each individual product contains less ingredients than a similar non-aerated product. Accordingly, it is desirable to provide aerated food products that do not provide a significant amount of calories yet still provide healthy ingredients.

### SUMMARY

According to one aspect of the disclosure, an aerated food product is described. In one embodiment, the food product includes a base ingredient, a protein and a liquid and, in some instances, a carbohydrate source. The base ingredient may include a whole grain source, a fiber source, a fruit source, a vegetable source, or any combination thereof. In some aspects, the finished food product has a moisture content in the range of about 1% to about 5%. In one embodiment, the finished food product has a density in the range of about 0.02 g/cc to about 0.50 g/cc. In some embodiments the finished food product has a porosity in the range of about 15% to about 65%. In some embodiments, the finished food product has a texture hardness in the range of about 1 to about 7 kg.

The whole grain source may include whole grains include grains like wheat, corn, rice, oats, barley, quinoa, sorghum, spelt, rye. In one aspect, the whole grain is oat or barley.

In one aspect, the base ingredient includes a whole grain source and fiber source. In this aspect, a carbohydrate source may be present and may include a sweetener. The finished food product may have one or more of the following physical attributes: a moisture content in the range of about 1% to about 5%, a density in the range of about 0.02 g/cc to about 0.50 g/cc, a porosity of about 15% to about 65%, and a texture hardness in the range of about 1 kg to about 7 kg.

In another aspect, the base ingredient includes a fruit source such that the product includes a fruit source, a protein source, and a liquid, that have been mixed and aerated to provide a finished food product that may have one or more of the following physical attributes: a moisture content in the range of about 1% to about 5%, a density in the range of about 0.02 g/cc to about 0.50 g/cc, a porosity of about 15% to about 65%, and a texture hardness in the range of about 1 kg to about 7 kg.

As used in this description, the term texture hardness refers to the peak force that occurs during the first compression of a sample tested using a TA.XT texture analyzer manufactured by Texture Technologies Corp. (Stable Micro Systems, Ltd.) Hamilton, MA or a similar texture analyzer. The testing used a compression probe with a test speed of 20.00 mm/sec and a post-test speed of 10.00 mm/sec over a 10.00 mm distance. The measurement and quantification of texture hardness correlates to a user's perception of a “first bite hardness” of a product.

The present disclosure also provides a method of making aerated food products. The method may involve combining a base ingredient or ingredients with a protein and liquid and, in some instances a carbohydrate to provide a mixture having a density in a range from about 0.1 g/ml to about 1.5 g/ml. The base ingredient may include a whole grain source, a fiber source, a fruit source, a vegetable source, or any combination thereof.

The mixture is then aerated under conditions effective to yield a stable aerated foam, which is then formed into various shapes. Thereafter, the foamed and shaped product is dried to remove the liquid (typically water) and/or moisture from the product as well as to “set” the product into its desired final shape. The final product will have a moisture content of less than about 5% by weight, e.g., in the range of about 1% to about 5%. In some instances, the moisture content is about 4%, about 3%, about 2% or about 1%.

Unless otherwise noted, all percentages used in this description refer to a percentage by weight.

### BRIEF DESCRIPTION OF THE DRAWINGS

The following description accompanies the drawing, all given by way of non-limiting examples that may be useful to understand how the described process and system may be embodied.

FIG. 1 depicts a proximate composition of unprocessed and processed (i.e., partially hydrolyzed) oat flour.

FIG. 2 is a flow sheet depicting one embodiment of the described process.

### DESCRIPTION

In one aspect, an aerated food product is described. The product includes a base ingredient, a protein and a liquid and, in some instances, a carbohydrate source. The base ingredient may include a whole grain source, a fiber source, a fruit source, a vegetable source, or a combination thereof. In some aspects, the finished product has a moisture content in the range of about 1% to about 5%. In one embodiment, the finished product has a density in the range of about 0.02 g/cc to about 0.50 g/cc. In some embodiments the finished product has a porosity in the range of about 15% to about 65%. In some embodiments, the finished product has a texture hardness in the range of about 1 kg to about 7 kg.

The base ingredient(s) may be provided as a solid such as a powder, a semi-solid, or a liquid.

### Whole Grain Source

Whole grains include grains like wheat, corn, rice, oats, barley, quinoa, sorghum, spelt, rye. In one aspect, the whole grain is oat or barley. The following description will refer primarily to oats but it should be understood that the reference to oats will be equally applicable to other whole grains.

Whole grains are desirable because they are a source of whole grain attributes and in some instances, can provide a desirable level of beta-glucan (at least 0.75 g soluble oat fiber per serving (about 18 g of whole grain oats)). In these instances, to provide additional health benefits to the product, the whole grains may be selected from oat and barley, which can provide a sufficient amount of beta-glucan to support a health claim (about 1 to 5 grams of beta-glucan per serving (140 grams of the product). However, in some instances, the use of whole grains may provide a finished product that has undesirable organoleptic qualities.

Accordingly, in certain aspects, the product includes whole grains with partially hydrolyzed starch. In some aspects, it may be beneficial to use “soluble flour” (e.g., “soluble pulse flour,” “soluble grain flour,” soluble whole grain flour,” “soluble bran flour,” “soluble oat flour,” or “soluble whole grain oat flour”), which refers to flour that maintains soluble components such as beta-glucan but also is highly dispersible in liquids such as water and retains its whole grain standard. The term “soluble flour” (e.g., “soluble pulse flour,” “soluble grain flour,” soluble whole grain flour,” “soluble bran flour,” “soluble oat flour,” or “soluble whole grain oat flour”) refers to flour that maintains soluble components such as beta-glucan but also is highly dispersible in liquids such as water.

The dispersibility of the flour may be measured in water observing formation of a lump and size of the lumps on the top and bottom of the water after stirring for five (5) seconds. “Highly dispersible” therefore means that there are no lumps present or formed after stirring the mixture for about 5 seconds. As the skilled artisan would recognize, stirring can also be interchanged with shaking or some other specific movement to incorporate and mix the flour into the liquid.

The term “regular oat flour,” “typical oat flour,” and “unprocessed oat flour” refers to whole oat flour that is made by conventional or traditional milling methods and not “soluble oat flour” or oat flour made in accordance with the methods described herein, unless otherwise clear from context. For example, a whole oat flour with partially hydrolyzed starch (e.g., soluble oat flour made using the described methods) can still qualify as a whole oat flour. Accordingly, the term “whole oat flour” in isolation can refer to unprocessed whole oat flour or whole oat flour in which starch has been hydrolyzed without converting the starch to monosaccharides and disaccharides. For example, the soluble whole oat flour (or other whole grain) made in accordance with the methods described herein can maintain its standard of identity as whole grain throughout processing.

The highly dispersible oat flour can be prepared using an extruder or other suitable continuous cooker. An example of a process for preparing a highly dispersible whole grain flour (e.g., soluble oat or barley flour) is found in U.S. Pat. No. 8,574,644, the entire contents of which is expressly incorporated herein by reference. In one embodiment, a method of producing soluble oat or barley flour includes using a pre-conditioner and an extruder or other suitable continuous cooker, which will partially hydrolyzed starch.

The highly dispersible oat flour may be prepared by combining a whole oat flour starting mixture and a suitable enzyme solution in a mixer (sometimes called a pre-conditioner) and then heating the mixture. The enzyme-treated mixture is then subjected to an extrusion process to hydrolyze, gelatinize, and cook the oat flour mixture.

The enzyme may be any suitable enzyme to partially hydrolyze the starch in the oat flour and does not change or adversely affect the beta-glucan that is present in the oat flour. Suitable enzymes include a-amylase in the range of about 0.01-0.5%, for example about 0.1-0.2%. In one aspect of the present disclosure, the a-amylase used may be Validase 1000 L having approximately 1,000,000 MWU/g (MWU—Modified Wohlgemuth Unit). Whether the beta-glucan has changed by the partial hydrolysis can be determined by any suitable method such as by analyzing the structure of the beta-glucan. This can be done by laser light scattering mass spectroscopy. The enzyme is added to water to form an enzyme water solution. Then, the enzyme-water solution is combined with the starting mixture in the pre-conditioner.

The starting mixture and enzyme solution is heated to between about 120° F. and about 200° F., in particular to between about 140° F. and about 180° F., e.g. 165° F. for about 3 to 5 minutes to initiate gelatinization of starch. The enzyme then reacts on gelatinized starch to break down some of the high molecular weight amylopectin starch fractions (having an average molecular weight of 5.8-6.2×10⁶ Dalton) into low molecular weight amylopectin starch fractions (having an average molecular weight of 1.7-2.0×10⁶ Dalton).

The starting mixture and enzyme solution may be mixed in any suitable vessel such as a high speed mixer that permits liquid to be added to free-flowing flour. The output is a free-flowing wetted flour mixture having a moisture content of about 25 to about 40%. The residence time is the time sufficient to obtain the desired result and typically 1 to 5 min.

The enzyme-treated mixture is subsequently added to an extruder (continuous cooker) to hydrolyze, gelatinize, and cook the starch. The mixture resides in the extruder for a time sufficient to gelatinize and cook the starch, but not long enough to dextrinize or otherwise modify the starch to void the whole grain aspect, generally at least 1 minute, typically, about 1 to about 1.5 minutes. Generally, the material is heated from an initial inlet temperature to a final exit temperature in order to provide the energy for starch gelatinization.

Starch gelatinization requires water and heat. The gelatinization temperature range for oats is 127° F. to 138° F. (53-59° C.). If the moisture is less than about 60% then higher temperatures are required.

Heat may be applied through the extruder barrel wall such as with a jacket around the barrel through which a hot medium like steam, water or oil is circulated, or electric heaters imbedded in the barrel. Typically the extrusion occurs at barrel temperatures between 140° F. and 350° F., for example between 175° F. and 340° F., more specifically about 180° F.-300° F.

Heat is also generated within the material by friction as it moves within the extruder by the dissipation of mechanical energy in the extruder, which is equal to the product of the viscosity and the shear rate square for a Newtonian fluid. Shear is controlled by the design of the extruder screw(s) and the screw speed. Viscosity is a function of starch structure, temperature, moisture content, fat content and shear. The temperature of the dough increases in the extruder to approximately 212° F. and 300° F.

Low shear is applied to the mixture in the extruder. As the enzyme has preconditioned the starch, high shear is not required for this process. High shear can dextrinize the starch reducing its molecular weight too much. It can also increase the dough temperature excessively, which can overcook it resulting in too much cooked grain flavor. It is noted that the barrel temperature and the dough temperature may be different.

The process balances limiting the dough temperature to avoid too much cooked grain flavor and to keep the enzyme active. The process is balanced such that the dough temperature rises to a sufficient temperature to deactivate the enzyme. Such temperatures are at least 280° F., generally 212° F. to 300° F. A low shear extrusion process is characterized relative to high shear extrusion by high moisture and a low shear screw design versus low moisture and a high shear screw design.

Any suitable extruder may be used including suitable single screw or twin screw extruders. Typical, but not limiting, screw speeds are 200-350 rpm.

The resulting product may be pelletized using a forming extruder and dried, typically to about 1.5 to about 10%, for example 6.5 to 8.5%, moisture content. The pellets may be granulated to a max 5% though a US 40 screen. The particle size of the resulting granulated product is about 10-500 microns, for instance, about 1-450 microns, more particularly about 30-420 microns.

Jet milling may be used to mill the pellets produced in accordance with aspects of the present disclosure. Jet milling creates ultrafine particles. In particular, jet milling reduces the particle size of the pelletized soluble oat flour to less than about 90 micron, for example, less than about 50 microns, such as about 46 microns. As one of ordinary skill in the art would recognize, alternative milling processes can be used to reduce the particle size or micronize the flour to, 0.5-50 microns, such as between 10 to 50 microns.

The resulting soluble oat flour includes beta glucan soluble fiber, such as beta-1,3-glucan, beta-1,6-glucan, or beta-1,4-glucan or mixtures thereof In addition to beta glucan naturally present in the oats, beta glucan may also be added as approved by the FDA. In certain embodiments, the oat flour preferably contains at least about 3% to 5% or about 3.7% to 4% beta glucan.

Such a soluble oat flour may be known as “SoluOat 100” or “SoluOat 100 flour”, whether used in the singular or plural form. As used in this description, the terms refer to 99.5% whole oat flour made in accordance with the methods described above (to produce a soluble whole oat flour that maintains its whole grain status and is highly dispersible) and 0.5% mixed tocopherol.

As noted above, in some embodiments, the soluble whole oat flour (or other whole grain) made in accordance with the described methods maintains its standard of identity as a whole grain throughout processing (e.g., starch hydrolysis, pelletizing, drying, and/or grinding). “Whole grain” or “standard of identity as whole grain” shall mean that the cereal grain, for example, oat, “consists of the intact, ground cracked or flaked caryopsis, whose principal anatomical components—the starchy endosperm, germ and bran—are present in approximately the same relative proportions as they exist in the intact caryopsis.” (See, AACC International's Definition of “Whole Grains,” approved in 1999, available at http://www.aaccnet.org/initiatives/definitions/pages/wholegrain.aspx (last accessed Feb. 11, 2016).) Further, if the principal nutrients (i.e., starch, fat, protein, dietary fiber, beta-glucan, and sugar) are present in approximately the same relative proportions for a partially hydrolyzed grain and the original grain, it can be assumed that the processed grain (e.g., the partially hydrolyzed grain) maintains its whole grain status. However, since the average molecular weight of starch (e.g., amylopectin) in whole grains varies widely across the various types of whole grains (e.g., 1-400 million Dalton) and even among whole grain oat products, a shift in starch moieties from higher molecular weight to lower molecular weight does not alter whole grain status if the total starch content remains the same.

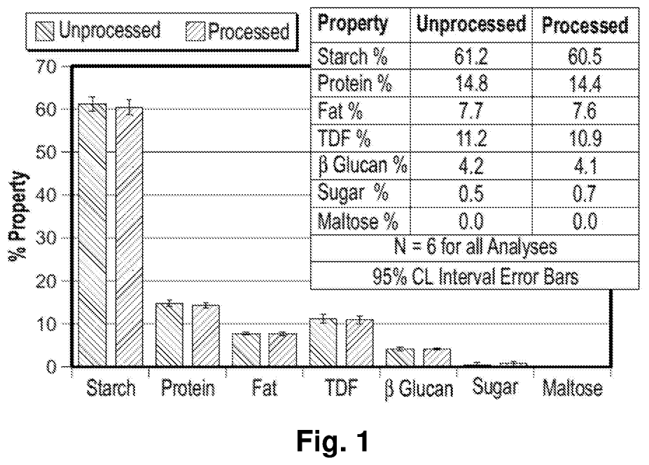

As shown, for example, in FIG. 1, the processed oat flour made in accordance with the instant disclosure maintains substantially the same levels of starch, protein, fat, total dietary fiber (TDF), glucan, sugar and maltose as the unprocessed oat flour when considered in terms of relative mass ratios of the components to starch.

Typically, the whole grain source is present in the mixture prior to aerating and drying in an amount in the range of about 5% to about 20%, or from about 6% to about 10%, or about 10% to about 20% or about 7% to about 13%. In some aspects, the whole grain source is present in 140 grams of the finished aerated product to provide from about 5 grams to about 25 grams of whole grain.

### Fiber Source

The base ingredient may include a fiber source alone, i.e., with no other ingredients forming the base ingredient, or in combination with a whole grain source.

The fiber source may be selected from, but not limited to, polydextrose, inulin, maltodextrin, non-digestible oligosaccharides, such as fructo-oligosaccharides (FOSs), galacto-oligosaccharides, and gluco-oligosaccharides and combinations thereof.

FOSs belong to the group of prebiotics because of their indigestibility nature. Prebiotics are defined as non-digestible food ingredients that beneficially affect the host by stimulating the growth and/or activity of beneficial bacteria in the colon. FOSs have Generally Recognized As Safe (GRAS) status.

Gluco-oligosaccharides are recognized as non-digestible oligosaccharides (NDOs) which are produced by enzymatic reaction of a glucosyltransferase. When a specific glucosyltransferase such a dextransucrase is used in the presence of an acceptor such as maltose or glucose and sucrose as D-glucosyl donor, a-gluco-oligosaccharides are obtained, which in some cases contain α-1,2 and α-1,6 glucosidic bonds. These a-gluco-oligosaccharides are resistant to attack by the digestive enzymes in humans and animals and therefore are not metabolized.

The fiber, when present, may be present in the mixture prior to aerating and drying in a range from about 5% by weight to about 40%, or from about 10% to about 30% or from about 15% to about 25%. In some instances, the fiber is present in an amount of about 16%.

Fruits and/or Vegetables

Suitable fruits include, but are not limited to, strawberry, melons (e.g., watermelon, honeydew melon, cantaloupe, etc.), blackberry, blueberry, cherry, apple, banana, raspberry, mango, papaya, orange, pear, tangerine, tomato (also referred to herein as a vegetable), cranberry, nectarine, kiwi, lemon, grapefruit, grape, plum, etc.

Suitable vegetables include, but are not limited to, carrot, peppers (e.g., green peppers, red peppers, etc.), beets, beans (e.g., green beans, lima beans, etc.), peas, potato, sweet potato, broccoli, tomato (also referred to herein as a fruit), celery, spinach, zucchini, cucumber, cauliflower, onion, scallion, asparagus, garlic, corn, etc.

As indicated above, a mixture of two or more different fruits with one another, a mixture of two or more different vegetables with one another, or a mixture of two or more different fruits and different vegetables with one another is contemplated. Therefore, any combination of fruits with fruits, vegetables with vegetables, and fruits with vegetables is contemplated.

It is also contemplated to provide a fruit and/or vegetable source in combination with a whole grain source, either with a fiber source or in the absence of a fiber source.

The fruit or vegetable can be from any portion of the source fruit plant or vegetable plant. Such portions of source plant can include, without limitation, leaves, stems, stalks, fruit tissue, seeds, roots, flowers, flower buds, etc. Further, the plant can be made from particular categories of plant portions, such as root portions (e.g., carrots, beets, etc.), leaf/stalk portions (e.g., broccoli florets, spinach leaves, celery stalks), and fruit portions (e.g., tomato fruit, strawberry fruit, orange fruit). The fruit and/or vegetable can be provided in any suitable form, although it is generally contemplated to provide the fruit and/or vegetable as a solid such as a powder.

The fruit and/or vegetable may be present in the mixture prior to aerating and drying in a range from about 15% to about 50%, or from about 20% to about 40%, or from about 25% to about 35%.

In one embodiment, the base ingredient is present in the finished aerated product in an amount ranging from about 2% by weight to about 50% by weight based on total dry weight. Although a beginning and ending percent by weight is provided, the present invention is not limited to those upper and lower limits but also includes all percentages by weight falling within those upper and lower limits.

### Protein

As noted above, the base ingredient or ingredients are combined with a protein. The protein for the aerated product may be selected from, but not limited to, egg whites, albumin, gelatin, animal plasma, whey protein, canola protein, canola protein isolates, pea protein, pea protein isolate, soy protein, potato, canola, chickpea broth/aquafaba, milk, and combinations thereof. In some instances, the protein is egg white or albumin. The protein generally makes up about 1% to about 20% by weight of the composition prior to aerating and drying. In some instances, the protein may be present in the composition prior to aerating and drying in an amount from about 8% to about 18% by weight.

The amount of protein present in the product prior to aerating and drying may depend in part on the type of finished product being produced. For example, if the finished product is an aerated fruit product, the amount of protein may be lower than if the finished product is a whole grain flour product.

### Liquid

The base ingredient and protein are combined with a liquid. The liquid can be any liquid suitable for forming an aerated product. In one embodiment, the liquid should be able to combine and mix with other ingredients, in particular the dry ingredients. The liquid is generally selected from, but not limited to water, glycerin, propylene glycol, sugar syrup (corn syrup, hydrogenated starch hydrolysate, glucose syrup), raw egg white, and combinations thereof. Prior to drying, the liquid may be present in a range from about 30% to about 80% by weight, from about 40% to about 70% by weight. In some instances, the liquid may be present in an amount from 45% to about 60% by weight prior to aerating and drying.

### Additional Ingredients

While the base ingredient(s), protein, and liquid form the mixture, it is contemplated that other ingredients may be included in the mixture, particularly one or more carbohydrates.

The carbohydrates may be selected from, but not limited to, sugar, corn syrup, dextrose, glycerin, hydrocolloids (starches, gums,), flour, hydrogenated starch hydrolysate, and combinations thereof. The carbohydrate source, when present, may be present in a range from about 1% to about 20% by weight of the mixture prior to aerating and drying or from about 4% to about 7% by weight.

It is contemplated that the mixture may contain additional components such as stabilizers, preservatives, palatants, flavor enhancers, and combinations thereof. The additional components may be selected from, but not limited to, gums such as gum acacia, agar, xanthan gum and propylene glycol alginate, salt, citric acid, tartaric acid, gelatin, and combinations thereof.

The moisture content of the formed and foamed product is generally less than about 5% by weight of the final product and may be about 4%, about 3%, about 2% or about 1%. The final product may have a porosity in the range from about 15% to about 65%. The final product may also have a density in the range of about 0.02 g/cc to about 0.50 g/cc, or from about 0.04 g/cc to about 0.40 g/cc, or about from about 0.05 to about 0.20 g/cc. The final product may have a texture hardness in the range of about 1 kg to about 7 kg.

### Method

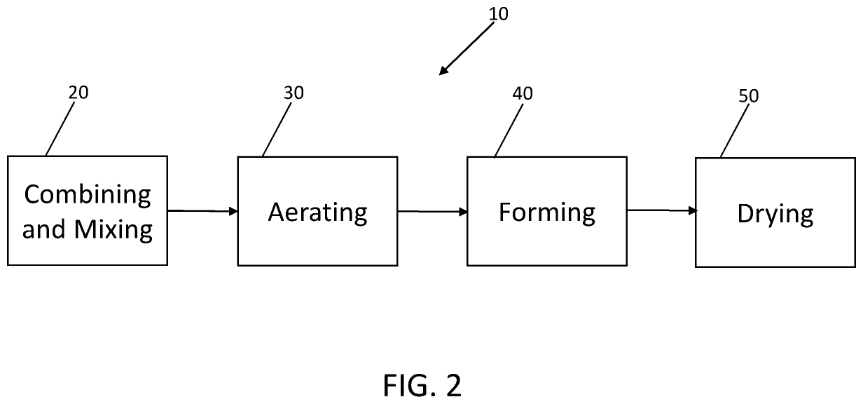

A method for preparing aerated food products will now be described with reference to FIG. 2. The method 10 generally includes combining and mixing 20 a base ingredient or ingredients with protein and liquid and, in some instances a carbohydrate to provide a mixture. The mixing may be accomplished using any well-known mixer such that all the ingredients are sufficiently combined to provide a viscosity at 25° C. that is 60,000 cP or less, and is typically in the range from about 2,000 cP to about 60,000 cP. The mixed components typically have a density of about 0.10 g/ml to about 1.5 g/ml, or about 0.5 to about 1.4 g/ml, or about 0.9 to about 1.3 g/ml before aeration.

After mixing, the mixture is aerated or whipped at step 30 so that air bubbles form within the mixture. The aerating or whipping step 30 for the methods of the present invention can be accomplished using any method that aerates or whips the ingredients forming air bubbles within. The aerating or whipping step 30 may be accomplished using a method selected from, but not limited to, a bowl and a whipping blade; an aerator, or a continuous mixer. Suitable aerators are an Oakes Continuous Mixer Aerator (Asser Oakes, Cheshire, England) or a TFT-Rotoplus aerator from Tanis Food Tec.

Typically, the aeration is performed to produce a finished aerated product having a density in the range of about 0.02 g/cc to about 0.50 g/cc, or from about 0.04 g/cc to about 0.40 g/cc, or about from about 0.05 to about 0.20 g/cc.

One of skill will understand that using a commercial aerator, parameters such as input flow rate of the mixture, pressure, and gas flow rate can be varied in a known manner to achieve the desired density of the aerated product. In an embodiment where an aerator is used, the air flow in cubic feet per minute (cfm) generally ranges from about 0.0751 to 0.1328 cfm. As an example, when the mixed components have a density of 1.3 g/ml, the flow rate may range from 0.0794 cfm to 0.1328 cfm; for a density of 1.2 g/ml, the flow rate may range from 0.0774 cfm to 0.1259 cfm, and for a density of 1.1 g/ml, the flow rate may range from 0.0751 cfm to 0.1255 cfm. The operating pressure may be between 5-120 psi.

The aerated (whipped) composition is then formed at step 40 onto a surface and dried at step 50 such that the formed and aerated composition stabilizes resulting in a cooked finished product. Other ingredients, such as those described above, can be added to the mixture during or prior to the whipping or aerating process.

The aerated composition can be formed into various shapes. Any shape that is attractive and desired by consumers will be suitable. The shapes can be formed manually or by machine. When formed by a machine, the shapes may be produced using a depositing machine having various nozzles to create a plethora of shapes or may be produced using a wire-cut apparatus.

One type of depositing machine is a manifold depositing system by Wymbs (Stockport, UK). Another example of a depositor machine is a Polin Multidrop (Verona, Italy). Advantageously, a depositing machine avoids pressurization and compression of the foam and minimizes breakdown of the aerated surface.

The drying step 50 of the method of the present invention is operable to remove water and/or moisture from the composition as well as to set the finished product into its desired formed shape. The drying can be carried out using any heat source which stabilizes foam-type compositions suitable for consumption. Preferably, the heat source is selected from, but not limited to, a conventional oven, a convection oven having one or more zones, a vacuum oven, a super-heated steam oven, a gas fired drier, heated air streams, infrared heat systems, and a microwave oven. In one embodiment, the temperature may range from about 100° C. to about 150° C., or from about 110° C. to about 140° C., or from about 120° C. to 140° C.

The drying time may range from about 1 minute to about 20 minutes, or about 5 minutes to about 15 minutes, or about 10 minutes to about 15 minutes, or about 11, 12, 13, or 14 minutes.

As noted above, the resulting product has a moisture content of less than about 5% by weight of the final product. In some instances, the moisture content is about 4%, about 3%, about 2% or about 1%.

The resulting product also has a porosity in the range of about 15% to about 65%, or in the range of about 15% to about 30%, and in some instances greater than about 20%. The final product may also have a density in the range of about 0.02 g/cc to about 0.50 g/cc, or from about 0.04 g/cc to about 0.40 g/cc, or about from about 0.05 g/cc to about 0.20 g/cc.

The method may include a cooling step (not shown) after the drying step. The cooling step can be carried out using any cooling method known in the art. In one instance, the cooling is accomplished using ambient temperature, forced air cooling, or combinations thereof. The cooling step may take from about 1 to 40 minutes, or from about 3 to 30 minutes, or from about 5 to 25 minutes, or from about 8 to 15 minutes, and in some cases about 10 minutes.

In an alternate embodiment, the finished product, after cooling, may be subjected to the addition of inclusions and coatings, such as, but not limited to, fats, flavorants, functional ingredients, nutraceuticals, vitamins, biological additives, heat sensitive ingredients, and combinations thereof. Alternatively, these coatings may be added to the aerated and deposited composition prior to the drying step 50.

In other embodiments, compositions formed from the methods described above may include, consist essentially of, or consist of (i) a base ingredient that includes a whole grain source, a fiber source, a fruit source, a vegetable source, or any combination thereof, (ii) a protein, (iii) a carbohydrate, (iv) a fiber, and (v) a liquid. In some instances, the compositions may consist essentially of a (i) base ingredient that is a whole grain source, a fiber source, a fruit source, a vegetable source, or any combination thereof, (ii) a protein, and (iii) a liquid. Alternatively, the compositions may consist of a (i) base ingredient that is a whole grain source, a fiber source, a fruit source, a vegetable source, or any combination thereof, (ii) a protein, and (iii) a liquid.

### Examples

Illustrative embodiments of the compositions, components, and/or methods of the present disclosure are provided by way of the following examples. While the concepts and technology of the present disclosure are susceptible to broad application, various modifications, and alternative forms, specific embodiments are described. It should be understood, however, that there is no intent to limit the concepts of the present disclosure to the particular forms disclosed, but on the contrary, the intention is to cover all modifications, equivalents, and alternatives consistent with the present disclosure and the appended claims.

The following example describes a fiber product.

TABLE 1
Fiber Product

| Ingredients | wt % |
|---|---|
| Water | 30-40 |
| Sugar | 10-20 |
| Polydextrose | 10-20 |
| Inulin | 10-20 |
| Gums | ≤1 |
| Salt | ≤1 |
| Citric Acid | ≤1 |
| Tartaric Acid | ≤1 |
| Albumin | 10-20 |
| Flavors | ≤1 |
| Total | 100 |

It will be appreciated that the above product provides a substantial amount of fiber (polydextrose and inulin) as part of the overall composition.

The following examples describe a whole grain product.

TABLE 2
Whole Grain Product

| Ingredients | wt % |
|---|---|
| Sugar | 2-6 |
| Polydextrose | 2-6 |
| Inulin | 5-15 |
| Albumin | 8-16 |
| Gums | 0.1-0.5 |
| Salt | 0.03-1.2 |
| Citric Acid | 0.08-0.3 |
| Tartaric Acid | 0.04-0.1 |
| Soluble Oat Flour | 6-9 |
| Water | 50-65 |
| Total | 100 |

TABLE 3
Whole Grain Products

| | Cereal | Snack size |
|---|---|---|
| | 8 g WG/40 g Final | 8 g WG/28 g Final |
| Ingredients | Product (wt %) | Product (wt %): |
| Sugar | 4-8 | 4-8 |
| Polydextrose | 2-4 | 2-4 |
| Inulin | 9-11 | 7-9 |
| Albumin | 15-18 | 12-16 |
| Citric Acid | 0.1-0.3 | 0.2-0.4 |
| Tartaric Acid | | 0.05-1.5 |
| Soluble Oat Flour | 8-12 | 11-18 |
| Flavor | 0.1-0.3 | 0.1-0.3 |
| Water | 45-60 | 15-60 |
| TOTAL | 100 | 100 |

WG = whole grain

It will be appreciated that the whole grain products in Table 3 provide a significant amount of whole grain in each serving size, i.e., either 40 g as a cereal product or 28 g as a snack product. It will also be appreciated that the described compositions may comprise, consist essentially of, or consist of a soluble whole grain (oat or barley), a protein, a carbohydrate, and a fiber.

The following example describes a fruit product.

TABLE 4
Fruit Product

| Ingredient | wt % |
|---|---|
| Water | 65-75 |
| Fruit Powder | 25-35 |
| Albumin | 0.5-2.5 |
| Total | 100 |

Advantageously, the above fruit product possess a clean label and the product comprises, consists essentially of, or consists of water, a fruit or fruit powder, and a protein, particularly albumin. It will be appreciated that the above fruit product does not contain any sugar; accordingly suitable fruit and vegetable compositions are free of sugar.

The following example describes a vegetable product.

TABLE 5
Vegetable Product

| Ingredients | wt % |
|---|---|
| Water | 50-60 |
| Polydextrose | 10-20 |
| Inulin | 10-20 |
| Gums | 0.1-0.5 |
| Salt | 0.4-1.3 |
| Citric Acid | 0.05-0.25 |
| Tartaric Acid | 0.05-0.25 |
| Albumin | 5-15 |
| Gelatin | 1-5 |
| Vegetable Powder | 1-6 |
| Total | 100 |

It will be appreciated that the vegetable product described in Table 5 above not only contains a vegetable (and vegetable flavor) but also provides a significant amount of fiber (polydextrose and inulin).

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. An aerated food product comprising:
a base ingredient that includes at least one of a whole grain source, a fiber source, a fruit source, a vegetable source, or any combination thereof;
a protein;
a liquid; and
optionally, a carbohydrate source,
wherein the aerated food product has a moisture content less than about 5% by weight and a density in the range of about 0.02 g/cc to about 0.50 g/cc.

2. The food product of claim 1 wherein the product has a porosity in the range of about 15% to about 65%.

3. The food product of claim 2 wherein the product has texture hardness in the range of 1 kg to 7 kg.

4. The food product of claim 1 wherein the base ingredient comprises a whole grain source that includes at least one of a wheat, corn, rice, oats, barley, quinoa, sorghum, spelt, or rye.

5. The food product of claim 4 wherein the whole grain source is oats or barley.

6. The food product of claim 4 where the whole grain source is a highly dispersible whole grain flour.

7. The food product of claim 6 wherein 100 g of the aerated finished product contains at least 20 g of whole grains.

8. The food product of claim 3 wherein the protein is selected from the group consisting of egg whites, albumin, gelatin, animal plasma, whey protein, canola protein, canola protein isolates, pea protein, pea protein isolate, soy protein, potato, canola, chickpea broth/aquafaba, milk, and combinations thereof.

9. The food product of claim 4 further comprising a carbohydrate source that is a sugar or source of sugar.

10. A method for making an aerated product comprising:
mixing a base ingredient, a protein, a liquid, and, optionally a carbohydrate to form a mixture; wherein the base ingredient includes whole grain source, a fiber source, a fruit source, a vegetable source, or any combination thereof;
aerating the mixture;
subsequently, forming the aerated mixture into a formed shape; and,
drying the formed shape to provide a finished aerated product having a moisture content less than about 5% by weight and a density in the range of about 0.02 g/cc to about 0.50 g/cc.

11. The method of claim 10 wherein the mixture has a density of about 0.1 g/ml to about 1.5 g/ml.

12. The method of claim 11 wherein the mixture has a viscosity of about 2,000 cP to about 60,000 cP.

13. The method of claim 10 wherein the finished aerated product has a porosity in the range of about 15% to about 65%.

14. The method of claim 13 wherein the finished aerated product has a texture hardness in range of about 1 kg to about 7 kg.

15. The method of claim 10 wherein the mixture consists essentially of a base ingredient, a protein, and a liquid.

16. The method of claim 10 wherein the base ingredient comprises a fruit, a vegetable, or a combination of a fruit and a vegetable.

17. The method of claim 15 wherein the base ingredient is a whole grain source.

18. The method of claim 17 wherein the whole grain source is a highly dispersible whole grain flour.

19. The method of claim 18 wherein 100 g of the aerated finished product contains at least 20 g of whole grains.
